(19) United States
(12) Patent Application Publication
(10) Pub. No.: US 2023/0105379 A1
(43) Pub. Date: Apr. 6, 2023

(54) FLIGHT ROUTE SELECTION DEVICE AND PROGRAM

(71) Applicant: KDDI CORPORATION, Tokyo (JP)

(72) Inventors: Sou YAMAZAKI, Tokyo (JP); Hiroshi KAWANA, Tokyo (JP)

(73) Assignee: KDDI CORPORATION, Tokyo (JP)

(21) Appl. No.: 17/953,471

(22) Filed: Sep. 27, 2022

(30) Foreign Application Priority Data
Sep. 29, 2021 (JP) 2021-158639

(51) Int. Cl. G08G 5/00; H04W 40/12

(52) U.S. Cl. CPC G08G 5/006; G08G 5/0039; G08G 5/0013; G08G 5/0026; G08G 5/0069; H04W 40/12

(57) ABSTRACT

A flight route selection device includes a storage unit that stores three-dimensional communication quality information in which a communication quality of wireless communication is associated with a three-dimensional position, a scheduled flight route acquisition unit that acquires a scheduled flight route indicating a latitude and a longitude of a flight device, a route generation unit that generates a plurality of routes having the same latitude and longitude as the scheduled flight route and having a different altitude from the scheduled flight route, a communication quality specifying unit that specifies a communication quality when the flight device flies along each route by acquiring a communication quality corresponding to a three-dimensional position of each route from the three-dimensional communication quality information, and a route selection unit that selects one route in which the specified communication quality is higher than those of other routes from among the plurality of routes.

### CROSS REFERENCE TO RELATED APPLICATION

Priority is claimed on Japanese Patent Application No. 2021-158639, filed Sep. 29, 2021, the content of which is incorporated herein by reference.

### BACKGROUND OF THE INVENTION

### Field of the Invention

The present invention relates to a flight route selection device and a program for generating a flight route of a flight device.

### Description of Related Art

A technology of generating a flight route of a flight device is known. Japanese Unexamined Patent Application, First Publication No. 2016-184288 discloses a technology for generating a flight route corresponding to flight performance of a flight device.

The technology disclosed in Japanese Unexamined Patent Application, First Publication No. 2016-184288 does not consider whether or not communication is possible between the flight device and another device such as a control device that controls the flight device. Therefore, there is concern that communication between the flight device in flight along a flight route and the other device may be interrupted.

### SUMMARY OF THE INVENTION

The present invention has been made in view of these points, and an object of the present invention is to select a flight route in which it is easy to maintain communication between a flight device and another device.

A first aspect of the present invention provides a flight route selection device including: a storage unit configured to store three-dimensional communication quality information in which a communication quality of wireless communication is associated with a three-dimensional position; a scheduled flight route acquisition unit configured to acquire a scheduled flight route indicating a latitude and a longitude of a flight device; a route generation unit configured to generate a plurality of routes having the same latitude and longitude as the scheduled flight route and having a different altitude from the scheduled flight route; a communication quality specifying unit configured to specify a communication quality when the flight device flies along each route by acquiring a communication quality corresponding to a three-dimensional position of each route from the three-dimensional communication quality information; and a route selection unit configured to select one route in which the specified communication quality is higher than those of other routes from among the plurality of routes.

The communication quality specifying unit may obtain a total value or average value of the communication qualities when the flight device flies along each route; and the route selection unit may select the route in which the obtained total value or average value of the communication qualities is largest among the plurality of routes as a flight route of the flight device.

The route generation unit may refer to the three-dimensional communication quality information to generate a plurality of routes that do not include positions at which the communication quality is equal to or lower than a predetermined quality.

The scheduled flight route acquisition unit may acquire the scheduled flight route including operation content or use of the flight device, and the route selection unit may select a route in which the specified communication quality is higher than those of the other routes and is a communication quality according to the acquired operation content or use from among the plurality of routes, as a flight route of the flight device.

The scheduled flight route acquisition unit may acquire the scheduled flight route including at least one of a type of the flight device, a model of the flight device, a performance of the flight device, and a specification of the flight device, and the route selection unit may select a route in which the specified communication quality is higher than those of the other routes and is a communication quality according to the acquired at least one of the type of the flight device, the model of the flight device, the performance of the flight device, and the specification of the flight device from among the plurality of routes, as a flight route of the flight device.

The flight route selection device may further include: a display control unit configured to cause a terminal to display the plurality of routes generated by the route generation unit in an aspect according to the communication quality of each route.

The flight route selection device may further include: a display control unit configured to cause a terminal to display a section having a lower communication quality than the other sections among a plurality of sections of the route selected by the route selection unit in an aspect different from those for the other sections.

The flight route selection device may further include: a quality information update unit configured to acquire measurement quality information in which a communication quality measured when the flight device flies along a flight route is associated with a position at which the communication quality has been measured, and update the communication quality associated with the position of the three-dimensional communication quality information corresponding to the position indicated by the measurement quality information with the communication quality indicated by the measurement quality information.

A second aspect of the present invention provides a non-transitory computer-readable recording medium having a program recorded thereon, the program causing a computer to perform the operation of: acquiring a scheduled flight route indicating a latitude and a longitude of a flight device; generating a plurality of routes having the same latitude and longitude as the scheduled flight route and having a different altitude from the scheduled flight route; specifying a communication quality when the flight device flies along each route by acquiring a communication quality corresponding to a three-dimensional position of each route from three-dimensional communication quality information stored in a storage unit in which a communication quality of wireless communication is associated with a three-dimensional position; and selecting one route in which the specified communication quality is higher than those of other routes from among the plurality of routes, as a flight route of the flight device.

According to the present invention, there is an effect that a flight route in which it is easy to maintain communication between a flight device and another device can be selected.

### BRIEF DESCRIPTION OF THE DRAWINGS

FIG. 1 is a schematic diagram illustrating a route selection system according to an embodiment of the present invention.

FIG. 2 is a block diagram illustrating a configuration of a route selection device according to an embodiment.

FIG. 3 is a diagram illustrating a three-dimensional communication quality map in an embodiment.

FIG. 4 is a diagram illustrating the communication quality of each block in an embodiment.

FIGS. 5A to 5C are diagrams illustrating a plurality of routes having different altitudes in an embodiment.

FIGS. 6A and 6B are diagrams illustrating routes having different altitudes in some sections in an embodiment.

FIG. 7 is a schematic diagram of a display screen on which a plurality of routes are displayed in an aspect according to a communication quality in an embodiment.

FIG. 8 is a schematic diagram illustrating a display screen on which a section having a lower communication quality than other sections is displayed in an aspect different from those for the other sections in an embodiment.

FIG. 9 is a flowchart illustrating an example of processing for selecting a flight route in an embodiment.

FIG. 10 is a diagram illustrating a route in which a latitude and a longitude have been changed in an embodiment.

### DETAILED DESCRIPTION OF EMBODIMENTS

An embodiment of the present invention will be described with reference to the drawings.

### [Overview of Route Selection System S]

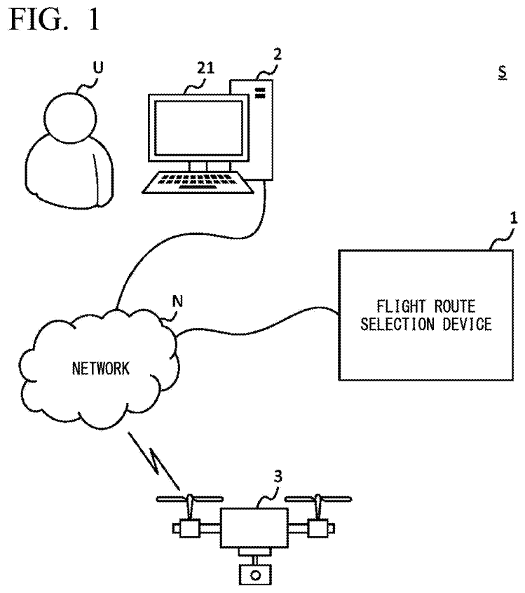

FIG. 1 is a diagram illustrating an overview of a route selection system S. The route selection system S is a system for selecting a flight route of a flight device 3. The route selection system S includes a flight route selection device 1, a terminal 2, and a flight device 3. The flight route selection device 1, the terminal 2, and the flight device 3 are communicatively connected via a network N.

The flight device 3 is, for example, a multicopter having a plurality of propellers. The flight device 3 includes, for example, a camera, and can transmit an image captured by the camera to the terminal 2 or the like.

The terminal 2 is a computer that is used by a user U who manages the flight device 3. The user U can input, to the terminal 2, a scheduled flight route along which the flight device 3 is scheduled to fly.

The flight route selection device 1 is a device that manages an operation of the flight device 3 and is, for example, a server. The flight route selection device 1 acquires the scheduled flight route input to the terminal 2 by the user U, and causes the flight device 3 to fly along the scheduled flight route. While the flight device 3 is flying along the scheduled flight route acquired from the flight route selection device 1, the flight device 3 periodically transmits telemetry data indicating a state of the flight device 3 including a position (latitude, longitude, and altitude), a flight speed, a remaining battery level, and the like of the flight device 3 to the flight route selection device 1.

Incidentally, a communication quality of wireless communication in the air in which the flight device 3 flies changes depending on an altitude. Therefore, when a communication quality at an altitude at which the flight device 3 flies is low, communication between the flight device 3 and the flight route selection device 1 or the terminal 2 may be interrupted. Because the telemetry data indicating the state of the flight device 3 such as the position or the remaining battery level of the flight device 3 cannot be acquired when the communication with the flight device 3 is interrupted, there is concern that the user U may not be able to appropriately monitor the state of the flight device 3.

Therefore, the flight route selection device 1 generates a plurality of routes having the same latitude and longitude as the scheduled flight route and a different altitude from the scheduled flight route. The flight route selection device 1 selects a route in which a communication quality is higher than the other routes among the plurality of generated routes as a candidate for the scheduled flight route of the flight device 3. The flight route selection device 1 causes the terminal 2 to display the selected candidate for the scheduled flight route. The user U can select one candidate as the scheduled flight route of the flight device 3 by selecting the one candidate from among the candidates for the scheduled flight route.

### [Configuration of Flight Route Selection Device 1]

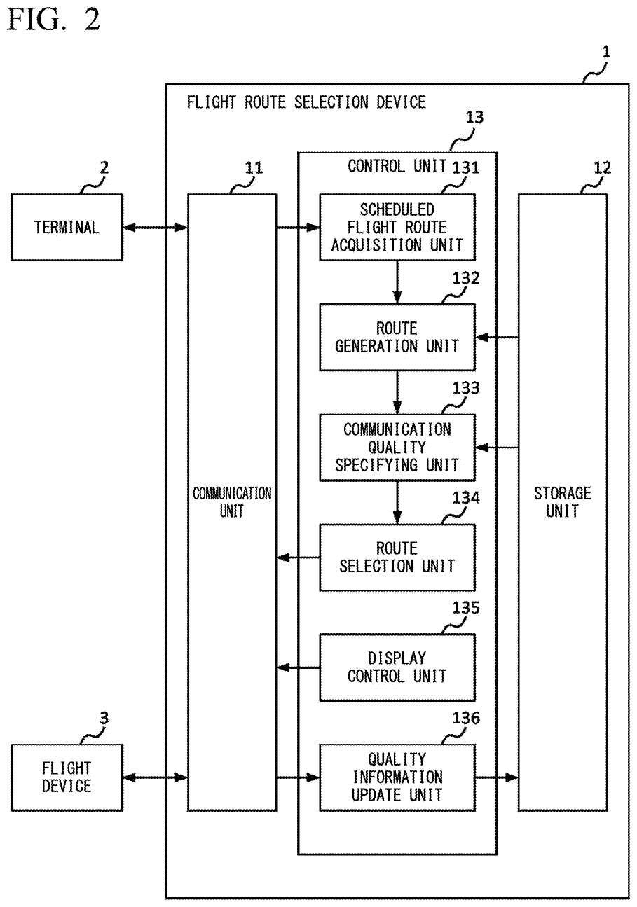

FIG. 2 is a diagram illustrating a configuration of the flight route selection device 1. The flight route selection device 1 has a communication unit 11, a storage unit 12, and a control unit 13.

The communication unit 11 is a communication module for communicating with the terminal 2 and the flight device 3. The communication unit 11 transmits or receives information to or from the terminal 2 and the flight device 3 via the network N. The communication unit 11 transmits, for example, an instruction input to the terminal 2 by the user U to the flight device 3. Further, the communication unit 11 transmits an image captured by the flight device 3 to the terminal 2.

The storage unit 12 is a storage medium including a read only memory (ROM), a random access memory (RAM), a hard disk, and the like. The storage unit 12 stores a program that is executed by the control unit 13.

The storage unit 12 stores a communication quality of wireless communication in the area (space) where the flight device 3 flies. For example, the storage unit 12 stores three-dimensional communication quality information in which a three-dimensional position is associated with a communication quality of wireless communication at the position. Specifically, the storage unit 12 stores three-dimensional communication quality information in which coordinates in a three-dimensional space represented by latitude, longitude and altitude are associated with a communication quality with which the flight device 3 has measured the coordinates during flight. The communication quality is represented by a numerical value from 0 to 10, for example. Specifically, the communication quality is determined on the basis of a signal-to-interference-plus-noise ratio (SINR), a reference signal received power (RSRP), a throughput, a response time, a delay time, and the like.

The storage unit 12 may store the communication quality of wireless communication in each of a plurality of spaces (hereinafter referred to as “blocks”) into which the three-dimensional space is divided in a predetermined reference size. For example, the storage unit 12 stores a database in which the communication quality of the block is associated with block identification information for identifying each block, as three-dimensional communication quality information. Hereinafter, a database in which a communication quality is associated with each block is referred to as a three-dimensional communication quality map. Specific values of the reference size are, for example, 100 meters in length, 100 meters in width, and 30 meters in height.

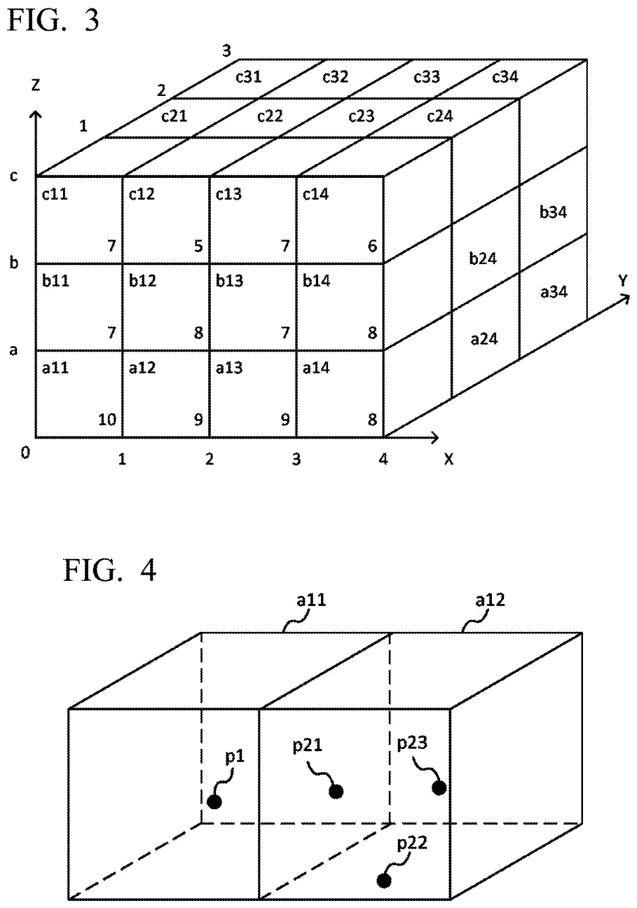

FIG. 3 is a diagram illustrating the three-dimensional communication quality map. In FIG. 3, an X axis indicates a latitude, a Y axis indicates a longitude, and a Z axis indicates an altitude. A scale of the X axis indicates a distance (unit: 100 meters) from a reference point (0 point). A scale of the Y axis indicates a distance (unit: 100 meters) from the reference point (0 point). A scale of the Z axis indicates a distance (an altitude) from a surface of the earth (0 meters). An altitude a indicates an altitude of 30 meters. An altitude b indicates an altitude of 60 meters. An altitude c indicates an altitude of 90 meters.

For example, [10] as the communication quality is associated with a block ID [a11]. That is, the three-dimensional communication quality map shows that the communication quality of the wireless communication in a case in which the flight device 3 flies within the block identified by the block ID [a11] is [10].

The size for division of the three-dimensional space is smaller than a standard size when it is easier for the communication quality to change, and larger than the standard size when it is difficult for the communication quality to change. For example, a size of a block in the sky above an urban area in which it is easy for a communication quality to change is smaller than the standard size. Further, a size of a block in the sky above a suburb in which it is difficult for a communication quality to change is larger than the standard size.

The storage unit 12 stores communication quality of the block that is based on a communication quality measured while the flight device 3 is flying in the block. FIG. 4 is a diagram illustrating the communication qualities of the respective blocks. The communication quality was measured while the flight device 3 was flying at a position of a point p1 in the block having the block ID [a11]. Further, the communication qualities were measured while the flight device 3 was flying at points p21, p22 and p23 in a block having a block ID [a12].

When one communication quality is measured during flying in one block of the flight device 3, the storage unit 12 stores the one communication quality as the communication quality of the one block. For example, when a communication quality measured while the flight device 3 is flying in the block having the block ID [a11] is only at the point p1, the storage unit 12 stores the communication quality at the point p1 as the communication quality of the block having the block ID [a11].

When a plurality of communication qualities are measured while the flight device 3 is flying in one block, the storage unit 12 stores one of the plurality of communication qualities as communication quality of the one block. Specifically, the storage unit 12 stores any of the lowest communication quality, the highest communication quality, or a communication quality measured immediately before among the plurality of communication qualities in the one block as the communication quality of the one block.

Further, when a plurality of communication qualities are measured in one block, the storage unit 12 may store an average value or a median value of the plurality of communication qualities as the communication quality of the one block. As an example, the storage unit 12 stores an average value of three communication qualities measured at the points p21, p22, and p23 in the block having the block ID [a12] as the communication quality of the block having the block ID [a12].

The control unit 13 is a calculation resource including a processor such as a central processing unit (CPU). The control unit 13 realizes functions of a scheduled flight route acquisition unit 131, a route generation unit 132, a communication quality specifying unit 133, a route selection unit 134, a display control unit 135, and a quality information update unit 136 by executing the program stored in the storage unit 12.

The scheduled flight route acquisition unit 131 acquires a scheduled flight route indicating a latitude and longitude of the flight device 3. For example, the scheduled flight route acquisition unit 131 acquires a scheduled flight route including a latitude and longitude indicating a start point of the flight device 3 and a latitude and longitude indicating an end point thereof from the terminal 2 via the network N. In this case, the user U inputs the scheduled flight route in which at least the latitude and longitude of the start point and the latitude and longitude of the end point have been designated, to the terminal 2. Further, the scheduled flight route acquisition unit 131 may acquire a scheduled flight route including latitudes and longitudes indicating one or more passing points, in addition to the start point and the end point. The scheduled flight route acquisition unit 131 may acquire the scheduled flight route not only from the terminal 2 but also from another device different from the flight route selection device 1 or another system different from the route selection system S.

The scheduled flight route acquisition unit 131 may acquire a scheduled flight route including operation content or use (hereinafter referred to as a “mode”) of the flight device 3 from the terminal 2. For example, the scheduled flight route acquisition unit 131 acquires a scheduled flight route including mode information indicating that a mode of the flight device 3 is a mode in which maintenance of communication connection is prioritized. The mode in which maintenance of communication connection is prioritized is, for example, a position recording mode in which the position of the flight device 3 is recorded. Further, the scheduled flight route acquisition unit 131 acquires a scheduled flight route including mode information indicating that the mode of the flight device 3 is a mode in which a route having a high communication quality is prioritized. The mode in which a route having a high communication quality is prioritized is, for example, a live moving image capturing mode in which a moving image captured by the flight device 3 is immediately transmitted. The scheduled flight route acquisition unit 131 may acquire mode information indicating that the mode of the flight device 3 is a delivery mode in which the flight device 3 delivers an article, and mode information indicating that the mode is a monitoring mode in which the flight device 3 monitors a monitoring target.

The scheduled flight route acquisition unit 131 may acquire a scheduled flight route including aircraft information indicating at least one of a type of the flight device 3, a model of the flight device 3, a performance of the flight device 3, and a specification of the flight device 3 from the terminal 2. In this case, the user U inputs the aircraft information to the terminal 2. The storage unit 12 may store at least one of the type of the flight device 3 and the model of the flight device 3 in association with at least one of the performance of the flight device 3 and the specification of the flight device 3. By doing so, the scheduled flight route acquisition unit 131 can acquire the performance and the specification of the flight device 3 simply by the user U inputting the type or model of the flight device 3, thereby reducing efforts for the user U to input the performance or the specification.

The route generation unit 132 generates a plurality of routes having the same latitude and longitude as the scheduled flight route and having a different altitude from the scheduled flight route. For example, the route generation unit 132 generates, for each of a plurality of altitudes, a route having the shortest distance from a position indicated by the latitude and longitude of the start point to a position indicated by the latitude and longitude of the end point. Further, when the scheduled flight route includes one or more passing points, the route generation unit 132 generates, for each of the plurality of altitudes, a route having the shortest distance from the start point to the end point via the one or more passing points.

The route generation unit 132 generates, for each of the plurality of altitudes, a route having the shortest distance in an area in which the flight device 3 can fly. In other words, the route generation unit 132 generates, for each of the plurality of altitudes, a route that does not pass through an area in which the flight device 3 cannot fly, and that has the shortest distance. The area in which the flight device can fly and the area in which the flight device cannot fly are determined according to the flight device 3. The area in which the flight device 3 can fly is determined in advance by, for example, a flight purpose and use of the flight device 3, an organization and a group causing the flight device 3 to fly, or the type of the flight device 3, the model of the flight device 3, the performance of the flight device 3, and the specification of the flight device 3. The area in which the flight device can fly and the area in which the flight device cannot fly may be stored in the storage unit 12, and the route generation unit 132 may acquire the areas from another device or another system.

The route generation unit 132 generates a route within a predetermined range from a minimum altitude to a maximum altitude. The maximum altitude is determined, for example, as an altitude (for example, 150 meters) that does not interfere with navigation of other aircraft such as jet planes. The minimum altitude is determined as an altitude (for example, 20 meters) at which there is no influence of noise or the like on animals existing on the surface of the earth. The minimum altitude and the maximum altitude are determined for each area. The route generation unit 132 generates a plurality of routes for each altitude within a range from the minimum altitude to the maximum altitude in an area including the scheduled flight route.

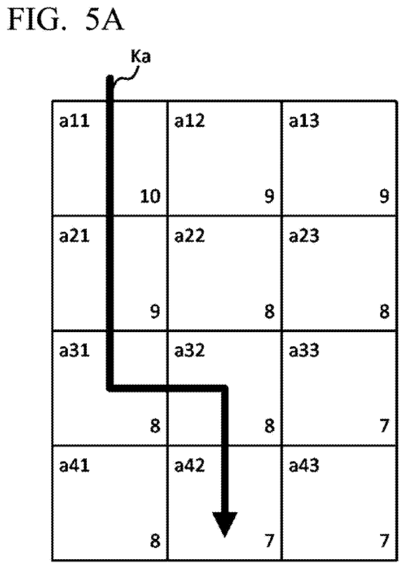

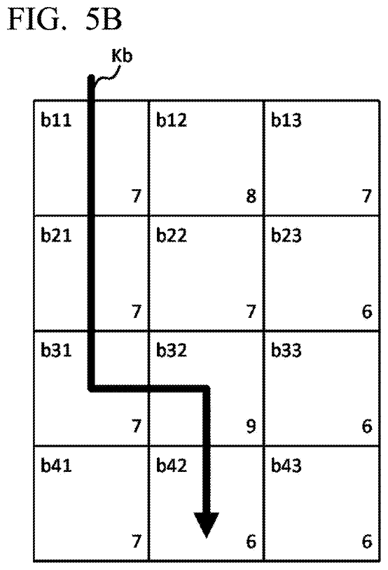

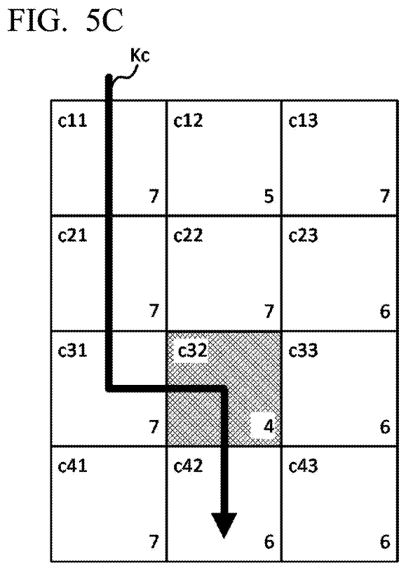

FIGS. 5A to 5C are diagrams illustrating a plurality of routes having different altitudes. FIGS. 5A to 5C are schematic views of an XY plane seen from above in a Z direction. A block ID is shown in an upper left of each block, and a communication quality of the block is shown in a lower right.

FIG. 5A is a diagram illustrating a communication quality on the XY plane at an altitude a. A solid arrow in FIG. 5A indicates a route Ka at the altitude a. FIG. 5B is a diagram illustrating a communication quality in the XY plane at an altitude b. A solid arrow in FIG. 5B indicates a route Kb at an altitude b. FIG. 5C is a diagram illustrating a communication quality of the XY plane at an altitude c. A solid arrow in FIG. 5C indicates a route Kc at an altitude c.

The route generation unit 132 refers to the three-dimensional communication quality map to generate a plurality of routes that do not include positions at which the communication quality is equal to or lower than a first quality threshold value. The first quality threshold value is a communication quality at which there is concern that the flight route selection device 1 cannot receive packets periodically transmitted from the flight device 3. Specifically, the route generation unit 132 determines that packets scheduled to be received cannot be received when at least one of SINR and RSRP is equal to or less than a predetermined value and the response time is equal to or longer than a predetermined time. In the present embodiment, the first quality threshold value is set to [4], and the route generation unit 132 does not create a route Kc passing through a block c32 whose communication quality is [4] or less. Further, when there is a block whose communication quality is equal to or lower than the first quality threshold value among a plurality of blocks including the generated route, the route generation unit 132 may discard the route.

The route generation unit 132 generates a new route that does not include positions at which the communication quality is equal to or lower than the first quality threshold value when the position at which the communication quality is equal to or lower than the first quality threshold value is included in the generated route. For example, the route generation unit 132 generates a new route having different altitudes in some of a plurality of sections included in the generated route when the position at which the communication quality is equal to or lower than the first quality threshold value is included in the generated route in the case of the position recording mode in which the maintenance of the communication connection is prioritized. Specifically, the route generation unit 132 generates a route in which latitudes and longitudes of respective sections are the same, and altitudes of some sections are different from those of some other sections.

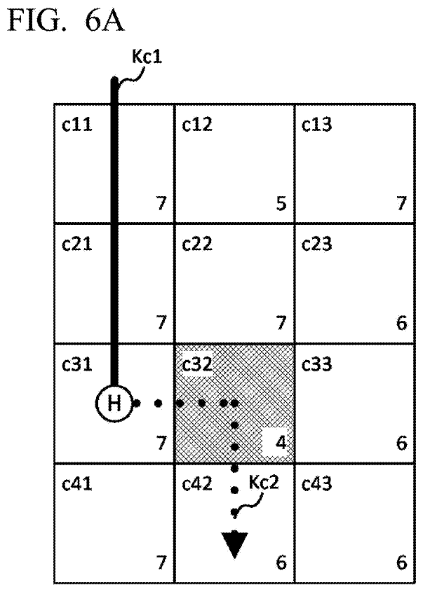

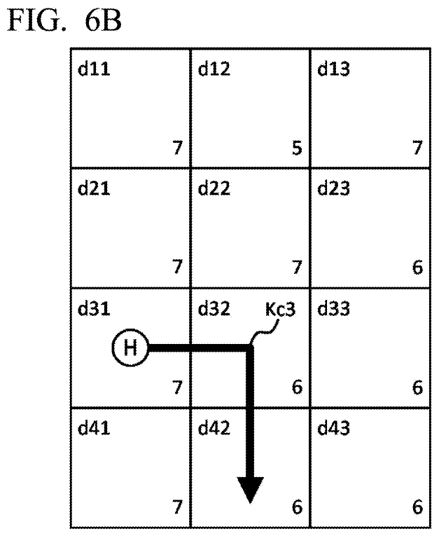

FIGS. 6A and 6B are diagrams illustrating routes having different altitudes in some sections. A section Kc1 in FIG. 6A is a section from a block c11 to a block c31. A section Kc2 is a section from the block c31 to a block c42 via a block c32. Because the section Kc2 is included in the block C32 in which the communication quality is equal to or lower than the first quality threshold value [4], the route generation unit 132 changes an altitude of the route at a position H in the block c31 before the block c32.

A block d31 in FIG. 6B and the block c31 are blocks having the same latitude and longitude and different altitudes. A section Kc3 in FIG. 6B is a section having the same latitude and longitude as the section Kc2 and a different altitude from the section Kc2. The section Kc3 is not included in the block in which the communication quality is equal to or lower than the first quality threshold value [4], and communication qualities in the block d31, a block d32, and a block d42 including the section Kc3 are all higher than the first quality threshold value. By doing so, the route generation unit 132 can generate the route that does not include the positions at which the communication quality is equal to or lower than the first quality threshold value.

The communication quality specifying unit 133 specifies communication quality when the flight device flies along each route. For example, the communication quality specifying unit 133 acquires a communication quality corresponding to a three-dimensional position of one route from the three-dimensional communication quality map, and obtains a total value or an average value of the communication qualities when the flight device flies along the one route as the communication quality of the one route.

The route selection unit 134 selects one of a plurality of routes in which the specified communication quality is higher than those of the other routes. Specifically, the route selection unit 134 selects a route in which the obtained total value or average value of the communication qualities is largest among the plurality of routes as the flight route of the flight device 3.

The route selection unit 134 selects a route having a communication quality according to the mode of the flight device 3 as the flight route of the flight device. For example, when mode information indicating the position recording mode in which the maintenance of communication connection is prioritized has been acquired, the route selection unit 134 selects a route in which a minimum value of communication quality in the plurality of sections included in each route is larger than that of other routes. Specifically, the route selection unit 134 selects the route in which the minimum value of the communication quality in the plurality of sections included in each route is largest. By doing so, the route selection unit 134 can select a route at an altitude at which interruption of communication can be curbed.

When mode information indicating the live moving image capturing mode in which the route having a high communication quality is prioritized is acquired, the route selection unit 134 selects a route in which a time in which the communication quality is equal to or lower than a second quality threshold value larger than the first quality threshold value is shorter than a predetermined time. The route selection unit 134 increases the second quality threshold value and decreases the predetermined time as an amount of data required to be transmitted per unit time increases. A specific value of the second quality threshold value is, for example, [6]. A specific value of the predetermined time is, for example, one minute. By doing so, the route selection unit 134 can shorten the time in which the communication quality becomes equal to or lower than the second quality threshold value in a flight time when the flight device 3 flies along the flight route. As a result, the route selection unit 134 can select a route at an altitude at which a communication quality enabling transmission of a large amount of data per unit time can be maintained.

When the flight device 3 is in the delivery mode, the route selection unit 134 selects a route in which communication is more likely to be maintained than the other routes and power consumption at the time of flight along the route is lower than the other routes, as the flight route of the flight device 3. Specifically, first, the route selection unit 134 estimates consumption of each route on the basis of a wind speed and direction at an altitude of the route, and whether the altitude has been changed. In a specific example, the route selection unit 134 increases estimated power consumption as the wind speed is higher when wind is headwind at the time of flight along the route and decreases the estimated power consumption as the wind speed is higher when the wind speed is tailwind. Further, the route selection unit 134 increases the power consumption in a case in which the altitude is changed larger than the power consumption in a case in which the altitude is not changed. The route selection unit 134 selects a route in which the minimum value of the communication quality in the plurality of sections included in each route is larger than that of the other routes and power consumption is lower than that of the other routes. By doing so, the route selection unit 134 can curb that the state of the flight device 3 cannot be monitored, such that the user U can appropriately monitor the delivery. Further, the route selection unit 134 can cause the flight device 3 to deliver an article with less power.

When the flight device 3 is in the monitoring mode, the route selection unit 134 selects a route having a higher communication quality of a block including the monitoring target than other routes, as the flight route of the flight device 3. By doing so, the route selection unit 134 can transmit data obtained by imaging the monitoring target as a high-quality image or moving image.

The route selection unit 134 may select a route in which a distance at which communication quality is equal to or lower than the second quality threshold value is smaller than a predetermined distance. The route selection unit 134 shortens the predetermined distance as the amount of data required to be transmitted per unit time increases. A specific value of the predetermined distance is, for example, one kilometer. By doing so, the route selection unit 134 can shorten the distance at which the communication quality becomes equal to or lower than the second quality threshold value in the flight distances when the flight device 3 flies along the flight route.

The route selection unit 134 selects a route according to the type information as the flight route of the flight device 3. For example, the route selection unit 134 selects the route on the basis of a camera type, e.e., at least one of the number of pixels of a camera mounted on the flight device 3, a communication type, i.e., a radio frequency that the flight device 3 can use for communication, and an influence type, i.e., the magnitude of an influence of wind on the flight device 3 in the type information.

For example, the route selection unit 134 selects a route in which a communication quality in a case in which the number of pixels of the mounted camera is large is higher than that in a case in which the number of pixels of the camera is small. As an example, when the number of pixels is large, the route selection unit 134 selects a route in which an average value of communication quality is largest. Further, when the live moving image capturing mode is acquired and the number of pixels of the mounted camera is large, the route selection unit 134 selects a route at an altitude at which a communication quality in the vicinity (that is, an area in which a live moving image is captured) of an imaging target is highest. By doing so, the route selection unit 134 can cause the flight device 3 to transmit a high-quality moving image without delay.

The route selection unit 134 selects a route in which a communication quality is higher than other routes in a frequency band that the flight device 3 can use for wireless communication. For example, when the flight device 3 can use long term evolution (LTE) and a 5th generation mobile communication system (5G) having a different frequency band from that of LTE, the route selection unit 134 selects a route having the highest communication quality among a communication quality of LTE and a communication quality of 5G. In this case, the communication quality specifying unit 133 specifies a communication quality when the flight device 3 communicates using LTE and a communication quality when the flight device 3 communicates using 5G when the flight device 3 flies along the route at each altitude. The route selection unit 134 selects a route having the highest communication quality among a plurality of specified communication qualities. By doing so, the route selection unit 134 can select a route in which a communication quality when the flight device flies along the route is higher than those of other frequency bands from among a plurality of frequency bands that can be used by the flight device 3.

The route selection unit 134 selects a route at an altitude with a lower wind speed as the influence of the wind on the flight device 3 is greater. For example, the influence of the wind on the flight device 3 decreases as a maximum wind pressure resistance of the flight device 3 increases. The maximum wind pressure resistance is defined as, for example, a maximum value of the wind speed at which the flight device 3 can hover stably. As an example, the flight device 3 having the maximum wind pressure resistance of 8 m/s can hover stably in a situation in which the wind speed is 8 m/s or less, and the flight device 3 having the maximum wind pressure resistance of 20 m/s or less can hover stably in a situation in which the wind speed is 20 m/s or less. Further, the influence of the wind increases as an aerodynamic resistance based on the size and shape of the flight device 3 increases.

The route selection unit 134 selects a route at an altitude with a lower wind speed as the maximum wind pressure resistance of the flight device 3 is smaller. Specifically, the route selection unit 134 selects a route at an altitude at which a communication quality is higher than those of other routes among routes at an altitude at which a wind speed is equal to or lower than the maximum wind pressure resistance of the flight device 3. By doing so, the route selection unit 134 can select a route in which the influence of the wind on the flight device 3 is small and the communication quality is high.

When a magnitude of sound generated during the flight of the flight device 3 is equal to or larger than a predetermined value, the route selection unit 134 may select a route whose communication quality is higher than those of the other routes and whose altitude is higher than those of the other routes. Specifically, the route selection unit 134 selects a route having the maximum altitude among a plurality of routes whose communication quality is higher than those of the other routes. By doing so, the route selection unit 134 can reduce an influence of noise on persons existing in an area in which the flight device 3 flies.

The display control unit 135 causes a display unit 21 of the terminal 2 to display the plurality of routes generated by the route generation unit 132. For example, the display control unit 135 causes the display unit 21 to display a plurality of routes generated for respective altitudes in the range from the minimum altitude to the maximum altitude in an area including the scheduled flight route, so that the routes are superimposed on the communication quality at the altitude. Specifically, the display control unit 135 causes the terminal 2 to display the routes in an aspect according to the communication qualities of the respective routes. As an example, the display control unit 135 causes the route in which a communication quality higher than the other routes to be displayed by a solid line, and causes the route having a lower communication quality than the other routes to be displayed by a dashed line.

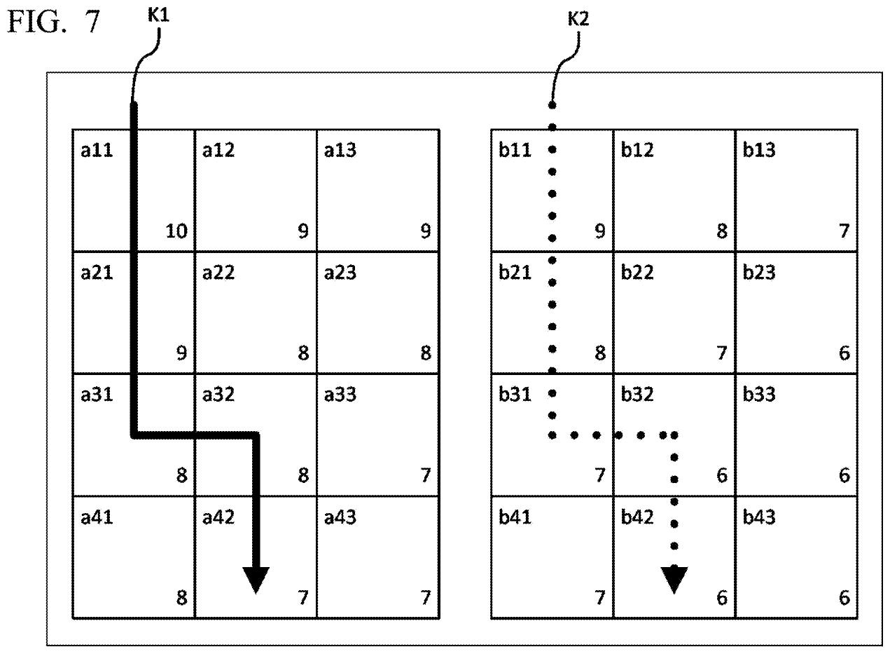

FIG. 7 is a schematic diagram of a display screen on which a plurality of routes are displayed in an aspect according to the communication quality. A route K1 is a route at an altitude a, and is displayed so that the route K1 is superimposed on a communication quality on an XY plane at the altitude a. A route K2 is a route at an altitude b and is displayed so that the route K2 is superimposed on a communication quality on an XY plane at the altitude b.

An average value of the communication quality of the route K1 is 8.4, and an average value of the communication quality of the route K2 is 7.2. Because the average value of the communication quality of the route K1 is larger than the average value of the communication quality of the route K2, the display control unit 135 causes the route K1 to be displayed by a solid line and causes the route K2 to be displayed by a dashed line. By doing so, it becomes easy for the user U who has confirmed the display screen to ascertain which route has a high communication quality.

The display control unit 135 causes the terminal 2 to display a section having a lower communication quality than those of the other sections among the plurality of sections of the flight route selected by the route selection unit 134 in an aspect different from those for the other sections. As an example, the display control unit 135 causes a section having a higher communication quality than other sections to be displayed by a solid line and causes a section having a lower communication quality than the other sections to be displayed by a dashed line.

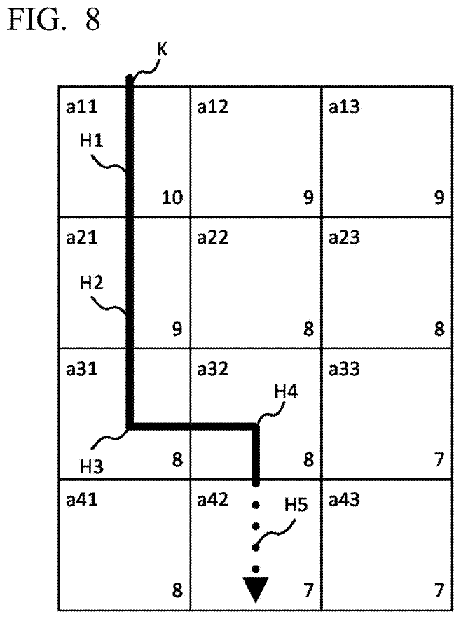

FIG. 8 is a schematic diagram of a display screen on which a section having a lower communication quality than the other sections is caused to be displayed in an aspect different from those for the other sections. A flight route K in FIG. 8 is a flight route selected by the route selection unit 134. Sections H1 to H5 in FIG. 8 are a plurality of sections included in the flight route K. Because the communication quality of the section H5 is lower than the communication qualities of the sections from the section H1 to the section H4, the display control unit 135 causes the section H5 to be displayed by a dashed line and causes the sections from the section H1 to the section H4 to be displayed by a solid line.

### [Processing for Updating Three-Dimensional Communication Quality Map]

A communication quality in the air changes depending on a surrounding environment or a radio wave situation in the air. Therefore, the three-dimensional communication quality map needs to be updated appropriately. Therefore, the quality information update unit 136 updates the communication quality of the three-dimensional communication quality map with the communication quality measured during the flight of the flight device 3.

First, the quality information update unit 136 acquires measurement quality information in which a communication quality measured when the flight device 3 flies along the flight route is associated with a position at which the communication quality has been measured. Specifically, the quality information update unit 136 acquires communication quality information in which a communication quality based on radio waves received by the flight device 3 or a radio wave strength of radio waves transmitted from the flight device 3 is associated with a position at which the flight device 3 has received the radio waves or a position at which the flight device 3 has transmitted the radio waves.

The quality information update unit 136 updates a communication quality associated with a position of the three-dimensional communication quality map corresponding to the position indicated by the measurement quality information with the communication quality indicated by the measurement quality information. Specifically, the quality information update unit 136 updates a communication quality in a block including the position at which the flight device 3 has received or transmitted the radio waves with the communication quality indicated by the measurement quality information. By doing so, the quality information update unit 136 can update the communication quality of each block with a value measured during the flight of the flight device 3.

### [Processing for Selecting Flight Route]

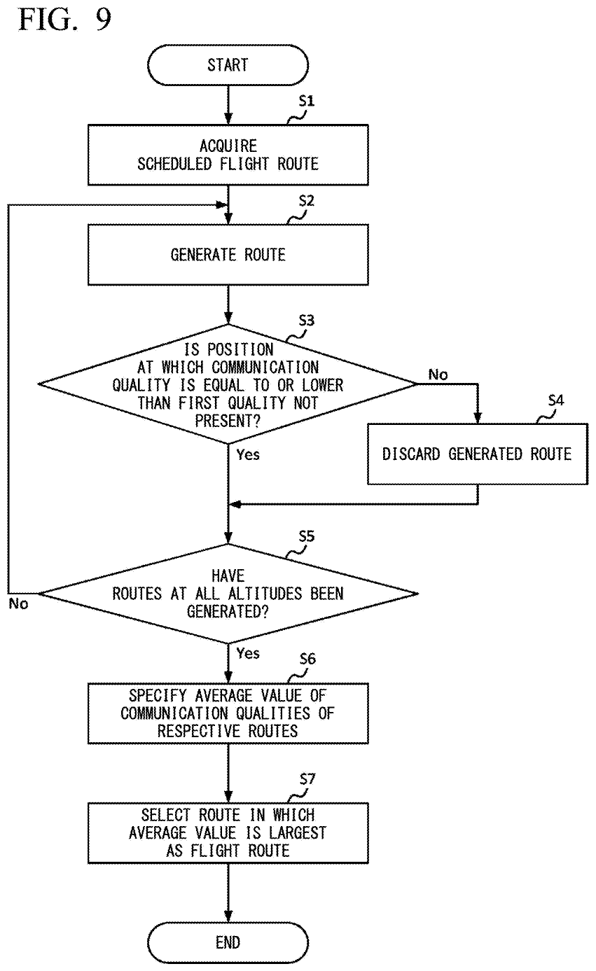

FIG. 9 is a flowchart illustrating an example of processing for selecting a flight route. The flowchart of FIG. 9 is executed, for example, when the flight route selection device 1 receives an instruction to select a flight route from the terminal 2.

First, the scheduled flight route acquisition unit 131 acquires the scheduled flight route including the start point and the end point of the flight device 3 from the terminal 2 (step S1). Specifically, the scheduled flight route acquisition unit 131 acquires the scheduled flight route including the latitude and longitude indicating the start point of the flight device 3 and the latitude and longitude indicating the end point thereof.

The route generation unit 132 generates a plurality of routes having the same latitude and longitude as the scheduled flight route and having a different altitude from the scheduled flight route (step S2). Specifically, the route generation unit 132 generates, for each of a plurality of altitudes, the route having the shortest distance from the position indicated by the latitude and longitude of the start point to the position indicated by the latitude and longitude of the end point.

The route generation unit 132 determines whether a position at which a communication quality is equal to or lower than the first quality threshold value in which there is concern that the communication with the flight device 3 is interrupted is not present in the generated route (step S3). When the position at which a communication quality is equal to or lower than the first quality threshold value is present in the generated route (No in step S3), the route generation unit 132 discards the generated route (step S4).

When the position at which the communication quality is equal to or lower than the first quality threshold value is not present in the generated route (Yes in step S3), the route generation unit 132 temporarily stores the generated route in the storage unit 12 and determines whether or not routes at all altitudes have been generated (step S5). When the route generation unit 132 has not generated the routes at all the altitudes (No in step S5), the route generation unit 132 returns to step S2 and generates routes at altitudes at which routes have not yet been generated.

The communication quality specifying unit 133 specifies the average value of the communication quality when the flight device 3 flies along the generated route (step S6). Specifically, the communication quality specifying unit 133 obtains the average value of the communication qualities of one or more blocks through which the flight device 3 passes when flying along each route. The route selection unit 134 selects the route in which the average value of the communication quality is largest among the plurality of routes, as the flight route of the flight device 3 (step S7).

### Modification Example

The route generation unit 132 may generate a route in which the latitude and the longitude have been changed when the altitude is changed. For example, the route generation unit 132 generates a route that bypasses a no-fly zone in which the flight device 3 cannot be caused to fly when a route after the altitude has been changed is included in the no-fly zone. The no-fly zone is, for example, an area above the maximum altitude or below the minimum altitude. The route generation unit 132 generates a route in which a distance from the position at which the altitude has been changed to the end point is shortest, with positions in the no-fly zone not included in the route. By doing so, the route generation unit 132 can generate a route in which it is easy for communication with the flight device 3 to be maintained and that has the shortest distance to the end point.

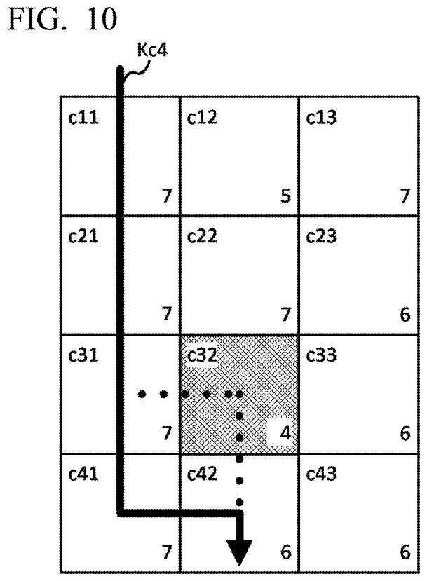

The route generation unit 132 may generate a route in which a latitude and longitude have been changed even when the altitude is not changed. Specifically, the route generation unit 132 generates a route in which at least one of the latitude and longitude of the scheduled flight route has been changed. FIG. 10 is a diagram illustrating the route in which the latitude and longitude have been changed. A route Kc4 in FIG. 10 is a route having a different latitude and longitude from the route Kc shown in FIGS. 5A to 5C, and is a route from a block c31 to a block c42 via a block c41. Thus, the route generation unit 132 can generate the route that does not include the positions at which the communication quality is equal to or lower than the first quality threshold value, by changing the route within the same altitude.

### [Effects of Flight Route Selection Device 1]

As described above, the flight route selection device 1 selects one route in which a communication quality when the flight device flies along one of the plurality of routes having the same latitude and longitude as the scheduled flight route and having a different altitude from the scheduled flight route is higher than those of the other routes. By doing so, the flight route selection device 1 can select a route at an altitude at which it is easy to maintain communication between the flight device 3 and another device such as the flight route selection device 1 and the terminal 2. As a result, because interruption of the communication between the flight device 3 and the other device is curbed, it is possible to reduce disabled control of the flight device 3 and to cause the flight device 3 to safely fly.

The present invention makes it possible to contribute to Goal 9 “Building a foundation for industry and technological innovation” of the Sustainable Development Goals (SDGs) led by the United Nations.

Although the present invention has been described above using the embodiment, the technical scope of the present invention is not limited to the scope described in the above embodiment, and various modifications and changes can be made within the scope of the gist. For example, all or part of the device can be configured to be functionally or physically distributed and integrated in any units. Further, a new embodiment resulting from any combination of the plurality of embodiments is included in the embodiments of the present invention. Effects of the new embodiment resulting from the combination include the effects of the original embodiment.

What is claimed is:

1. A flight route selection device comprising:
a storage unit configured to store three-dimensional communication quality information in which a communication quality of wireless communication is associated with a three-dimensional position;
a scheduled flight route acquisition unit configured to acquire a scheduled flight route indicating a latitude and a longitude of a flight device;
a route generation unit configured to generate a plurality of routes having the same latitude and longitude as the scheduled flight route and having a different altitude from the scheduled flight route;
a communication quality specifying unit configured to specify a communication quality when the flight device flies along each route by acquiring a communication quality corresponding to a three-dimensional position of each route from the three-dimensional communication quality information; and
a route selection unit configured to select one route in which the specified communication quality is higher than those of other routes from among the plurality of routes.

2. The flight route selection device according to claim 1,
wherein the communication quality specifying unit obtains a total value or average value of the communication qualities when the flight device flies along each route; and
the route selection unit selects the route in which the obtained total value or average value of the communication qualities is largest among the plurality of routes as a flight route of the flight device.

3. The flight route selection device according to claim 1, wherein the route generation unit refers to the three-dimensional communication quality information to generate a plurality of routes that do not include positions at which the communication quality is equal to or lower than a predetermined quality.

4. The flight route selection device according to claim 1,
wherein the scheduled flight route acquisition unit acquires the scheduled flight route including operation content or use of the flight device, and
the route selection unit selects a route in which the specified communication quality is higher than those of the other routes and is a communication quality according to the acquired operation content or use from among the plurality of routes, as a flight route of the flight device.

5. The flight route selection device according to claim 1,
wherein the scheduled flight route acquisition unit acquires the scheduled flight route including at least one of a type of the flight device, a model of the flight device, a performance of the flight device, and a specification of the flight device, and
the route selection unit selects a route in which the specified communication quality is higher than those of the other routes and is a communication quality according to the acquired at least one of the type of the flight device, the model of the flight device, the performance of the flight device, and the specification of the flight device from among the plurality of routes, as a flight route of the flight device.

6. The flight route selection device according to claim 1, further comprising:
a display control unit configured to cause a terminal to display the plurality of routes generated by the route generation unit in an aspect according to the communication quality of each route.

7. The flight route selection device according to claim 1, further comprising:
a display control unit configured to cause a terminal to display a section having a lower communication quality than the other sections among a plurality of sections of the route selected by the route selection unit in an aspect different from those for the other sections.

8. The flight route selection device according to claim 1, further comprising:
a quality information update unit configured to acquire measurement quality information in which a communication quality measured when the flight device flies along a flight route is associated with a position at which the communication quality has been measured, and update the communication quality associated with the position of the three-dimensional communication quality information corresponding to the position indicated by the measurement quality information with the communication quality indicated by the measurement quality information.

9. A non-transitory computer-readable recording medium having a program recorded thereon, the program causing a computer to perform the operations of:
acquiring a scheduled flight route indicating a latitude and a longitude of a flight device;
generating a plurality of routes having the same latitude and longitude as the scheduled flight route and having a different altitude from the scheduled flight route;
specifying a communication quality when the flight device flies along each route by acquiring a communication quality corresponding to a three-dimensional position of each route from three-dimensional communication quality information stored in a storage unit in which a communication quality of wireless communication is associated with a three-dimensional position; and
selecting one route in which the specified communication quality is higher than those of other routes from among the plurality of routes, as a flight route of the flight device.
